(19) United States
(12) Patent Application Publication
(10) Pub. No.: US 2009/0167655 A1
(43) Pub. Date: Jul. 2, 2009

(54) LIGHT EMISSION CONTROLLER AND LIQUID CRYSTAL DISPLAY APPARATUS INCLUDING LIGHT EMISSION CONTROLLER

(75) Inventors: Ken Ito, Kanagawa (JP); Masaki Tsuchida, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki kaisha Toshiba, Tokyo (JP)

(21) Appl. No.: 12/337,474

(22) Filed: Dec. 17, 2008

(30) Foreign Application Priority Data
Dec. 26, 2007 (JP) 2007-334781

(51) Int. Cl. G09G 3/36

(52) U.S. Cl. 345/87

(57) ABSTRACT

According to one embodiment, a light emission controller has a light-value-change detector and a lighting controller. The lighting-value-change detector is configured to detect a change in a lighting value of a plurality of light sources. The lighting controller is configured to turn on the plurality of light sources at a plurality of lighting timings within a lighting period defined between an initial lighting timing and a final lighting timing of the plurality of lighting timings by pulse width modulation in accordance with the change in the lighting value, a number of the lighting timings in a later lighting period of the lighting period being greater than a number of the lighting timings in an earlier lighting period of the lighting period.

### CROSS-REFERENCE TO RELATED APPLICATIONS

This application is based upon and claims the benefit of priority from Japanese Patent Application No. 2007-334781, filed Dec. 26, 2007, the entire contents of which are incorporated herein by reference.

### BACKGROUND

1. Field

One embodiment of the invention relates to a light emission controller that controls a light emission of a light emitter such as a backlight illuminating a liquid crystal panel and the like, and to a liquid crystal display apparatus including the light emission controller.

2. Description of the Related Art

A liquid crystal display apparatus has recently been used as an image display in a television, a personal computer, a mobile phone, and the like. Since a liquid crystal panel of the liquid crystal display apparatus does not emit light, a backlight is provided behind the liquid crystal panel so as to illuminate the backside of the liquid crystal panel in order to display images.

In a conventional liquid crystal display apparatus having a backlight, a display screen is divided into a plurality of areas with respect to light sources configuring the backlight, and each area of the display screen (referred to as screen area) is controlled as an area controlling.

Regarding the aforementioned liquid crystal display apparatus, it has conventionally been known to adjust a timing for initially turning on the backlight in accordance with a temperature of the liquid crystal display panel (for example, refer to Japanese Patent Application Publication (Kokai) No. H11-143389 and Japanese Patent Application Publication (Kokai) No. 2007-163701).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary exploded perspective view of a configuration of a liquid crystal display apparatus according to an embodiment of the invention;

FIG. 2 is an exemplary perspective view of a configuration of a light emission area and a light source in the embodiment;

FIG. 3 is an exemplary block diagram of a configuration of a backlight controller with a backlight and a liquid crystal panel in the embodiment;

FIG. 4A is an exemplary view of a display image of a video where areas A and B without hatchings correspond to bright areas and other areas with hatchings correspond to dark areas in the embodiment;

FIG. 4B is an exemplary view of the video of FIG. 4A after one frame in the embodiment;

FIG. 5A is an exemplary view of a lighting state of a light source area of the backlight corresponding to FIG. 4A in the embodiment;

FIG. 5B is exemplary view of a lighting state of the light source area of the backlight corresponding to FIG. 4B in the embodiment;

FIG. 6 is an exemplary view of a part where the lighting state of the backlight corresponding to FIGS. 5A and 5B is changed in the embodiment;

FIG. 7A is an exemplary view of a lighting state of the backlight on an arbitrary line, the lighting state being calculated by a correction coefficient calculator, in the embodiment;

FIG. 7B is an exemplary view of a correction coefficient as well in the embodiment;

FIG. 8A is an exemplary view of a video data value corresponding to FIG. 4A in the embodiment;

FIG. 8B is an exemplary view of a corrected video data value in the embodiment;

FIG. 9A is an exemplary view of a lighting pattern in which lighting timings are uniformly distributed within lighting period in the embodiment;

FIG. 9B is an exemplary view of a lighting pattern in which the lighting timings are converged to a final lighting timing within the lighting period in the embodiment;

FIG. 10A is an exemplary view of an increasing change in transmittance of the liquid crystal panel when the transmittance changes significantly in the embodiment;

FIG. 10B is an exemplary view of a decreasing change in transmittance of the liquid crystal panel when the transmittance changes significantly in the embodiment;

FIG. 11A is an exemplary view of when the backlight is lighted in the lighting pattern in which the lighting timings are uniformly distributed within the lighting period, with respect to increasing transmittance in the embodiment;

FIG. 11B is an exemplary view of when the backlight is lighted in the lighting pattern in which the lighting timings are uniformly distributed within the lighting period, with respect to decreasing transmittance in the embodiment;

FIG. 12A is an exemplary view of when the backlight is lighted in the lighting pattern in which the lighting timings are converged to the final lighting timing within the lighting period, with respect to increasing transmittance in the embodiment;

FIG. 12B is an exemplary view of when the backlight is lighted in the lighting pattern in which the lighting timings are converged to the final lighting timing within the lighting period, with respect to decreasing transmittance in the embodiment;

FIG. 13 is an exemplary view of an image when bright and dark areas occurs in edge areas in a shift direction in the embodiment;

FIG. 14A is an exemplary view of another lighting pattern of the backlight when an initial time of lighting is changed in the embodiment; and

FIG. 14B is an exemplary view of still another lighting pattern of the backlight when the initial time of lighting and the second time of lighting are changed in the embodiment.

### DETAILED DESCRIPTION

Various embodiments according to the invention will be described hereinafter with reference to the accompanying drawings. The same reference numerals are provided for the same elements, and explanations thereof are omitted. In general, according to one embodiment of the invention, a light emission controller for controlling light emissions of a plurality of light sources included in a light emitter illuminating a liquid crystal panel by the plurality of light sources each of which is provided with respect to each of a plurality of light source areas, the light emission controller has a light-value-change detector and a lighting controller. The lighting-value-change detector configured to detect a change in a lighting value of the plurality of light sources. The lighting controller configured to turn on the plurality of light sources at a plurality of lighting timings within a lighting period defined between an initial lighting timing and a final lighting timing of the plurality of lighting timings by pulse width modulation in accordance with the change in the lighting value, a number of the lighting timings in a later lighting period of the lighting period being greater than a number of the lighting timings in an earlier lighting period of the lighting period.

Further, according to another embodiment of the invention, a liquid crystal display apparatus has a liquid crystal panel; a light emitter configured to illuminate the liquid crystal panel by a plurality of light sources each of which is provided with respect to each of a plurality of light source areas; a light emission controller configured to control a light emission of the plurality of light sources; a Lighting-value-change detector configured to detect a change in a lighting value of the plurality of light sources; and a lighting controller configured to turn on the plurality of light sources at a plurality of lighting timings within a lighting period defined between an initial lighting timing and a final lighting timing of the plurality of lighting timings by pulse width modulation in accordance with the change in the lighting value, a number of the lighting timings in a later lighting period of the lighting period being greater than a number of the lighting timings in an earlier lighting period of the lighting period.

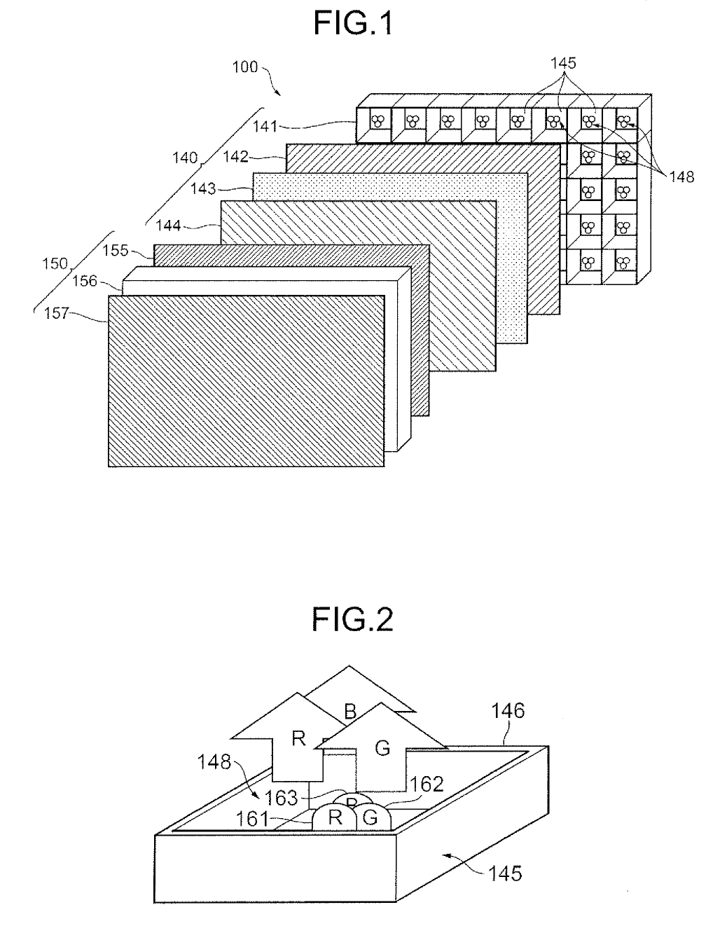

A configuration of a liquid crystal display apparatus 100 according to an embodiment of the present invention is described with reference to FIGS. 1 and 2. FIG. 1 is an exploded perspective view of the configuration of the liquid crystal display apparatus 100 according to the embodiment of the present invention, and FIG. 2 is a perspective view of a configuration of a light source area and a light source.

The liquid crystal display apparatus 100 is applied to a liquid crystal television and the liker and includes a backlight 140 and a liquid crystal panel 150 as shown in FIG. 1.

The backlight 140 has a light emitter 141 and a pair of diffuser plates 142, 144 that sandwich therebetween a prism sheet 143 provided in front of the light emitter 141.

The light emitter 141 has a panel shaper and has a matrix structure in which a plurality of light source areas 145 are regularly arranged in “m” lines and “n” columns in vertical and horizontal directions. FIG. 1 shows the light emitter 141 having the light source areas 145 arranged in 5 lines and 8 columns, as an example.

The light source area 145 is surrounded in four directions by partition walls 146 extending in a direction toward the diffuser plate 142 and the like, as shown in FIG. 2.

In each of the light source areas 145, a light source 148 configured by three LEDs 161, 162, 163 of RGB primary colors is disposed. The light source 148 is configured by the red LED 161, green LED 162, and blue LED 163. The light source 148 emits light in a forward direction (toward the liquid crystal panel 150) while mixing the three colors of red, green and blue. The light emitted from the respective light source areas 145 illuminates the back of the liquid crystal panel 150, and the transmission of the emitted light through the liquid crystal panel 150 is adjusted to display a video.

The liquid crystal display apparatus 100 is of a direct lighting type where the whole area of the backlight 140 emits light using the plural light sources 148 arranged in the respective light source areas 145 to illuminate the back of the liquid crystal panel 150.

The liquid crystal panel 150 includes a pair of polarizing plates 155, 157 and a liquid crystal 156 disposed therebetween.

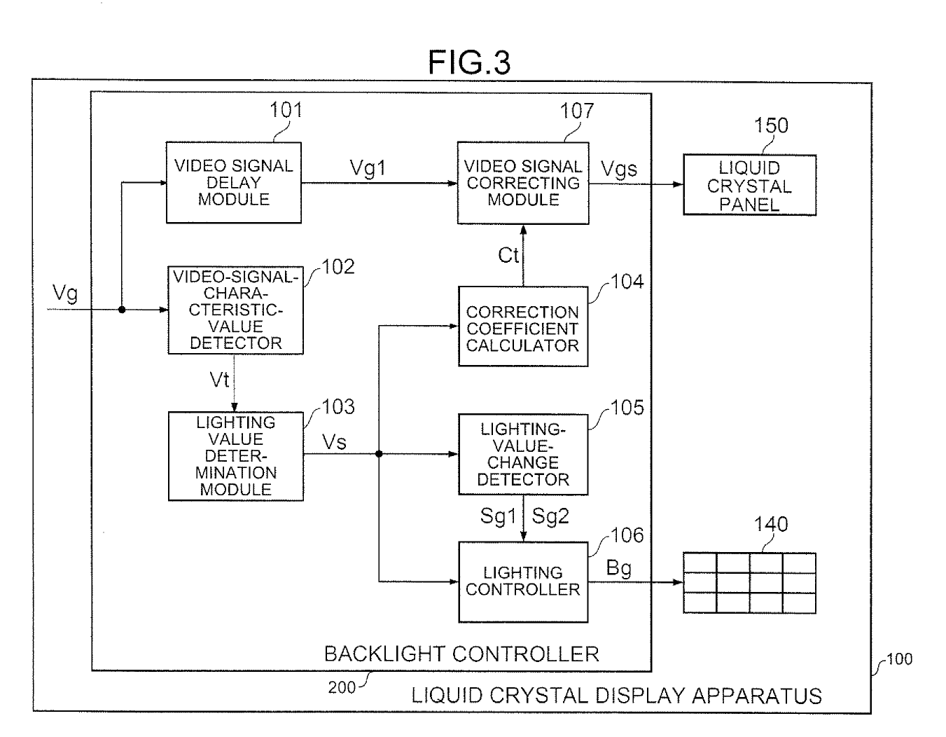

A configuration of a backlight controller 200 will be described with reference to FIG. 3. FIG. 3 is a block diagram of the configuration of the backlight controller 200 with the backlight 140 and the liquid crystal panel 150.

The backlight controller 200 is provided in the liquid crystal display apparatus 100 together with the backlight 140 and the liquid crystal panel 150, and has a function as the light emission controller controlling light emissions of the plural light sources 148 configuring the backlight 140.

The backlight controller 200 has a video signal delay module 101, a video-signal-characteristic-value detector 102, a lighting value determination module 103, a correction coefficient calculator 104, a lighting-value-change detector 105, a lighting controller 106 and a video signal correcting module 107.

The backlight controller 200 inputs a video signal Vg that is used to display a video on the liquid crystal panel 150.

The video signal Vg is input to the video signal delay module 101 and the video-signal-characteristic-value detector 102. The video signal delay module 101 delays the video signal Vg and outputs a delayed video signal Vg1 to the video signal correcting module 107. The video-signal-characteristic-value detector 102 detects a characteristic value Vt from the input video signal Vg, and outputs the characteristic value Vt to the lighting value determination module 103. The lighting value determination module 103 determines a lighting value of every light source area 145 based on the input characteristic value Vt, and outputs the determined lighting value as a lighting value data Vs to the correction coefficient calculator 104, the lighting-value-change detector 105, and the lighting controller 106.

The lighting-value-change detector 105 detects a change in the lighting value of every light source area 145 based on the lighting value data Vs, and outputs a change-detection data Sg1 indicating the detection result to the lighting controller 106. Further, the lighting-value-change detector 105 has a function as a determination module. That is to say, the lighting-value-change detector 105 determines whether the change in the lighting value in each light source area 145 is larger than a reference value based on the lighting value data Vs, and outputs a detection signal Sg2 indicating that the change in the lighting value is larger than the reference value to the lighting controller 106.

The lighting controller 106 outputs a lighting control data Bg by way of PWM in accordance with the change-detection data Sg1, and turns on the backlight 140. When the detection signal Sg2 is output from the lighting-value-change detector 105, the lighting controller 106 changes a lighting control data Bg and outputs the changed lighting control data Bg. As will be described in details hereinafter, when the detection signal Sg2 is output, the lighting controller 106 changes the lighting control data Bg so that a lighting pattern in which lighting timings are uniformly distributed within a lighting period of the light source 148 is changed to a lighting pattern in which lighting timings are converged to a final lighting timing within the lighting period of the light source 148, and outputs the changed lighting control data Bg. Accordingly, the light source 148 is turned on more in the later lighting period than the earlier lighting period.

The correction coefficient calculator 104 calculates a video signal correction coefficient Ct based on the lighting value data Vs. The correction coefficient calculator 104 outputs the calculated correction coefficient Ct to the video signal correcting module 107. The video signal correcting module 107 obtains a corrected video signal Vgs from the delayed video signal Vg1 of the video signal delay module 101 and the correction coefficient Ct, and outputs the obtained corrected video signal Vgs to the liquid crystal panel 150.

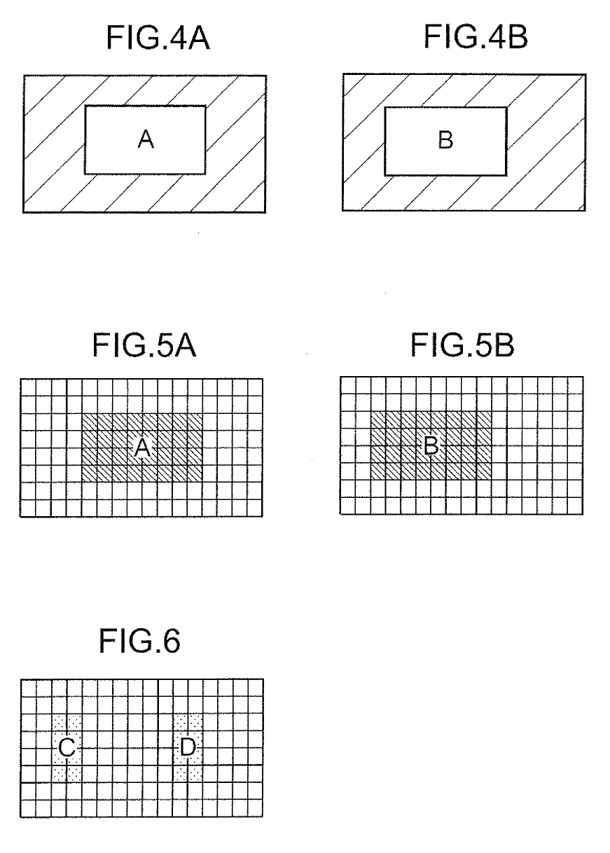

An operation of the backlight controller 200 having the above-described configuration will be explained with reference to FIGS. 4A and 4B.

FIGS. 4A and 4B show a video display image where areas A and B without hatchings correspond to bright areas and areas with hatchings correspond to dark areas. Here, FIG. 4B shows a video showing after one frame of FIG. 4A.

The lighting value data Vs is determined by the previously described video-signal-characteristic-value detector 102 and the lighting value determination module 103. Suppose that the lighting value data Vs is determined when an overlapped area of the area A and the area B is lighted. FIGS. 5A and 5B show respective lighting state of the light source areas 145 in the backlight 140r which are respectively corresponding to FIGS. 4A and 4B. In FIGS. 5A and 5B, areas A and B with hatchings show a lighted state. Here, each grid represents one light source 145. FIG. 4A corresponds to FIG. 5A and FIG. 4B corresponds to FIG. 5B.

The lighted light source areas 145 shift from the area A to the area B during the period (one frame period) r which is defined from when a frame of FIG. 4A is displayed till when a frame of FIG. 4B is displayed. Accordingly, a lighting value of the backlight 140 is changed in areas where the area A and the area B do not overlap, namely in an area C and an area D shown in FIG. 6. When the change in the lighting value is larger than a reference value, the detection signal Sg2 is output from the lighting-value-change detector 105. In the aforementioned one frame period, the lighting-value-change detector 105 determines that the change in the lighting value is larger than the reference value in the areas C and D.

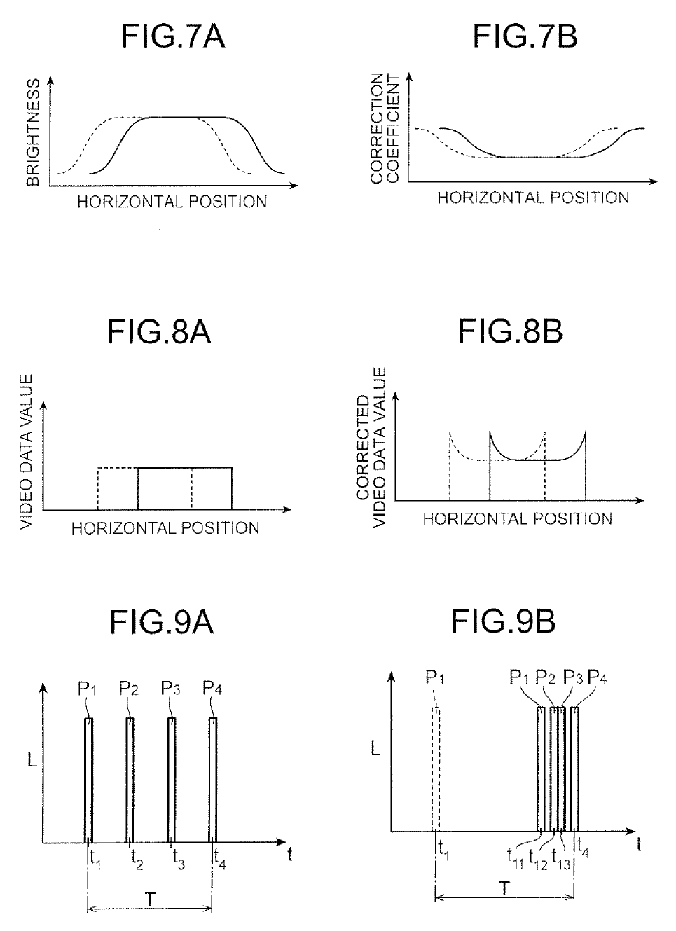

FIG. 7A shows a lighting state of the backlight 140 on one line calculated in the correction coefficient calculator 104, and FIG. 7B shows a correction coefficient as well. In FIGS. 7A and 7B, a solid line corresponds to FIG. 4A and a dotted line corresponds to FIG. 4B.

As shown in FIG. 7A, the superficial brightness of the backlight 140 decreases and its surface becomes darker as the horizontal position shifts away from the lighted position. Hence, in order to display with the former brightness, it is necessary to make the correction coefficient larger as the superficial brightness of the backlight 140 becomes farther away from the lighted position, as shown in FIG. 7B.

When a value of the video signal Vg (a video data value) shown in FIG. 8A is multiplied by the correction coefficient shown in FIG. 7B, a corrected video data value shown in FIG. 8B is obtained. Then, the corrected video signal Vgs like the aforementioned value is output to the liquid crystal panel 150. However, it becomes necessary to match a timing of a change in transmittance at the liquid crystal panel 150 corresponding to a difference between the solid line part and the dotted line part and a timing of a change in the timing of the lighting state of the backlight 140 shown in FIG. 7A.

In general, as it is pointed out that a moving image is blurred, it is widely known that a response speed is slow in the liquid crystal panel of the liquid crystal panel 150. That is to say, a certain time is required until a necessary transmittance is obtained for the video signal input to the liquid crystal panel. As a result, a time delay occurs with respect to the input timing of the video signals.

The response speed of LEDs such as the red LED 161 is fast in the backlight of the backlight 140 and the like. When a lighting control data is input to backlight at the same timing as the liquid crystal panel, the backlight is turned on at a desired brightness in a short period faster than the response speed in the liquid crystal panel. The backlight controller 200 takes into account this high speed response, and the backlight controller 200 time-divides the lighting time so as to perform a tone controlling by PWM (Pulse Width Modulation) which makes the backlight 140 to be turned on at a certain brightness for a plurality of times.

FIGS. 9A and 9B show one example of lighting patterns of the backlight 140 by PWM, and FIG. 9A shows the lighting pattern in which the lighting timings are uniformly distributed within the lighting period, and FIG. 9B shows the lighting pattern in which the lighting timings are converged to the final lighting timing within the lighting period. A horizontal axis indicates time t, and a vertical axis indicates brightness L. As shown in FIG. 9A, in the lighting pattern in which the lighting timings are uniformly distributed within the lighting period, lightings P1, P2, P3 and P4 are conducted at time t1, t2, t3 and t4 during the lighting period T that is defined from the initial lighting time t1 till the final lighting time t4. Accordingly, the backlight 140 is lighted so that the lighting timing is uniformly distributed during the lighting time T.

On the other hand, in the lighting pattern in which the lighting timings are converged to the final lighting timing within the lighting period, the lightings P1, P2, P3 and P4 are conducted at time t11, t12, t13, which are just before the final lighting time t4, and t4. Accordingly, the lightings are converged to the final time t4, and the light sources 148 are lighted (in a group).

A same gradation expression is capable of carrying out in both patterns of FIGS. 9A and 9B. However, instead of the pattern shown in FIG. 9A, regarding FIG. 9B, the backlight 140 can be initially turned on when the transmittance on the liquid crystal panel reaches to the desired value, although the response speed of the liquid crystal is slow.

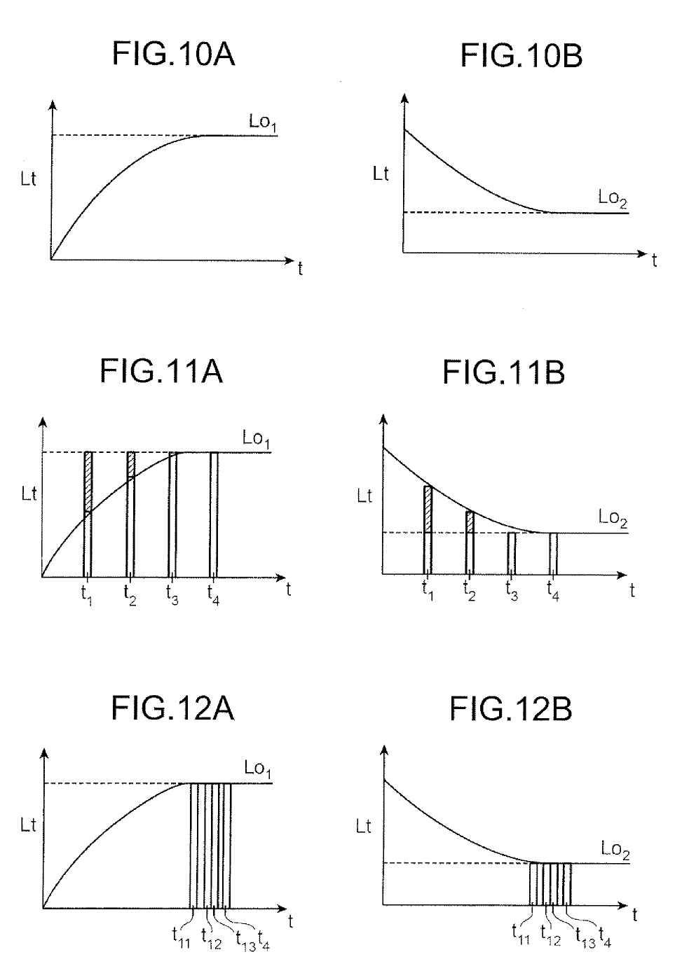

FIGS. 10A and 10B show a change in transmittance in the liquid crystal panel 150 when the transmittance changes significantly. In particular, FIG. 10A shows increasing transmittance, and FIG. 10B shows decreasing transmittance. The horizontal axis indicates time t and the vertical axis indicates transmittance Lt. Either of the figures shows that certain time is required until the transmittance reaches to the desired values Lo1 and Lo2 so that the response speed is slow in both patterns.

FIGS. 11A and 11B, FIGS. 12A and 12B show how the brightness of the liquid crystal panel 150 changes when the backlight 140 is lighted utilizing this liquid crystal panel 150.

FIGS. 11A and 11B show the case when the backlight 140 is turned on by the lighting pattern in which the lighting timings are uniformly distributed within the lighting period. In particular, FIG. 11A shows the increasing transmittance, and FIG. 11B shows the decreasing transmittance.

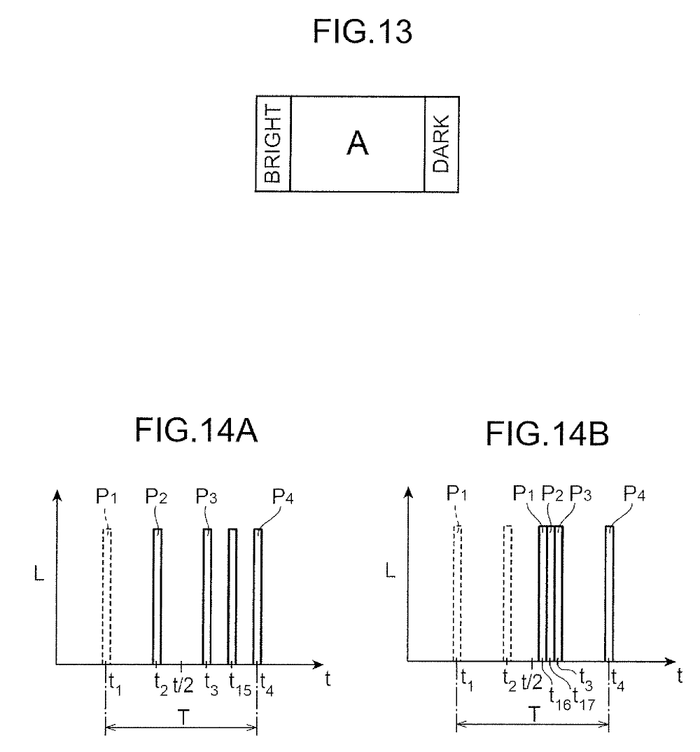

As shown in FIGS. 11A and 11B, the response speed is slow in the liquid crystal panel 150. Accordingly, even if the lightings P1, P2, P3 and P4 of the backlight 140 were conducted at time t1, t2, t3 and t4, hatching parts of FIGS. 11A and 11B appear as a difference between the desired value of the transmittance Lo1 and Lo2 when the transmittance changes significantly. Therefore, it is impossible to obtain a desired light amount on the liquid crystal panel 150. As a result, as shown in FIG. 13, bright and dark areas are to appear momentarily on the liquid crystal panel 150 due to the fact that the edge areas in the shift direction are not responded on time. Accordingly, an image quality is deteriorated.

On the other hand, FIGS. 12A and 12B show the case when the backlight 140 is turned on by the lighting pattern in which the lighting timings are converged to the final lighting timings within the lighting period. In particular, FIG. 12A shows increasing transmittance, and FIG. 12B shows decreasing transmittance.

In such case, since the backlight 140 is turned on at the moment when the transmittance nearly reaches the desired values Lo1 and Lo2, the desired light amount is obtained on the liquid crystal panel 150. Accordingly the bright and dark areas as shown in FIG. 13 are not to appear on the liquid crystal panel 150. Hence, deterioration of the image quality is prevented.

However, when the backlight 140 is turned on by the lighting pattern in which the lighting timings are converged to the final lighting pattern within the lighting period as shown in FIG. 9 while the change in the brightness is smaller than the desired value, a flicker that causes the image quality to deteriorate occurs on a screen. Hence, it is necessary to turn on the backlight in the lighting pattern in which the lighting timings are uniformly distributed in the lighting period at a normal operation state. Accordingly, in the backlight controller 200, the lighting controller 106 makes the backlight to be turned on in the lighting pattern in which the lighting timings are converged to the final timing within the lighting period only when the detection signal Sg2 is output from the lighting-value-change detector 105.

As described above, in the backlight controller 200, when the lighted state of the backlight 140 changes significantly, the backlight 140 is turned on in the lighting pattern in which the lighting timings are converged to the final lighting timing within the lighting period. Accordingly, the backlight 140 is turned on collectively in the later half of the lighting period T. As a result, when the lighting state of the backlight 140 changes significantly, the backlight controller 200 does not begin to turn on the backlight 140 until the transmittance of the liquid crystal panel 150 reaches to the desired value.

Accordingly, a difference between the timing when the lighting state of the backlight 140 changes and the timing when the transmittance of the liquid crystal panel 150 changes is reduced, and the video can be displayed with the desired brightness. Thus, it is possible to prevent an occurrence of a luminance change caused due to the fact that the change in the transmittance of the liquid crystal panel 150 is delayed with respect to the change in the lighting of the backlight 140 thereby an image quality deterioration is prevented. Moreover, since the number of lighting and the duration of lighting of the Light sources 148 are same between the lighting pattern in which the lighting timings are uniformly distributed within the lighting period and the lighting pattern in which the lighting timings are converged to the final lighting timing within the lighting period, an operating life of an element (an LED) is not influenced.

The aforementioned backlight controller 200 changes the lighting pattern of the backlight 140 to the lighting pattern in which the lighting timings are converged to the final lighting timing within the lighting period. However, the lighting pattern may be changed to the ones shown in FIGS. 14A and 14B.

In FIG. 14A, the initial lighting time t1 is changed to a lighting time t15 that is located between the third lighting time t3 and the final lighting time t4. This lighting pattern as well can turn on the backlight 140 more while the transmittance of the liquid crystal panel 150 is near the desired value. This is because it is possible to make the ratio of lighting higher in the later half of the lighting period T (the backlight 140 is turned on more in the later half of the lighting period in a lighting period T/2 which is half of the lighting period T rather than the earlier half of the lighting period)

In FIG. 14B, the initial lighting time t1 and the second lighting time t2 are changed to lighting times t16 and t17, which are just before the third lighting time t3. The lighting pattern as well turns on the backlight 140 more while the transmittance of the liquid crystal panel 150 is near the desired value. This is because it is possible to make the ratio of lighting higher in the later half of the lighting period T.

Accordingly, in FIGS. 14A and 14B as well, it becomes possible to prevent the occurrence of the luminance change caused due to the fact that the transmittance change of the liquid crystal panel 140 is delayed with respect to the lighting state change of the backlight 140, thereby the image quality deterioration is prevented. It becomes possible to prevent the occurrence of the luminance change caused due to the fact that the transmittance change of the liquid crystal panel 140 is delayed with respect to the lighted state change of the backlight 140, when the backlight 140 is lighted more in the later half of the lighting period T rather than the earlier half of the lighting period T by delaying at least one lighting time among the lighting times t1, t2, t3 and t4.

In the description as above, the case when the lighting controller 106 outputs the lighting control data Bg by way of PWM is descried as an example. However, it is also possible to apply this description to the case when the lighting controller 106 outputs the lighting control data Bg not by PWM.

The description as above is the description of the embodiments of the present invention and is not intended to limit apparatuses and methods of the invention, and various modified examples can be easily embodied. Further, an apparatus or a method realized by appropriate combination of the constituent elements, functions, features, or method steps in the embodiments are also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A light emission controller for controlling light emissions of a plurality of light sources included in a light emitter illuminating a liquid crystal panel by the plurality of light sources each of which is provided with respect to each of a plurality of light source areas, the light emission controller comprising:
a lighting-value-change detector configured to detect a change in a lighting value of the plurality of light sources; and
a lighting controller configured to turn on the plurality of light sources at a plurality of lighting timings within a lighting period defined between an initial lighting timing and a final lighting timing of the plurality of lighting timings by pulse width modulation in accordance with the change in the lighting value, a number of the lighting timings in a later lighting period of the lighting period being greater than a number of the lighting timings in an earlier lighting period of the lighting period.

2. The light emission controller according to claim 1, wherein
the lighting controller delays at least one of the lighting timings, and turns on the plurality of light sources at the lighting timings so that the plurality of light sources are turned on within the later lighting period.

3. The light emission controller according to claim 2, wherein
the lighting controller controls the lighting timings so that the lighting timings converges to the final lighting timing, and turns on the plurality of light sources at the lighting timings.

4. The light emission controller according to claim 1, further comprising:
a determination module configured to determine whether the change in the lighting value is greater than a predetermined reference value, wherein
the lighting-value-change detector outputs a detection signal when the determination module determines that the change in the lighting value is greater than the reference value, and
the lighting controller turns on the plurality of light sources at the lighting timings when the detected signal is output.

5. The light emission controller according to claim 4, wherein
the lighting controller uniformly distributes the lighting timings within the lighting period, and turns on the plurality of light sources when the detected signal is not output.

6. The light emission controller according to claim 1, further comprising:
a lighting value determination module configured to determine the lighting value of the plurality of light sources based on an input video signal, wherein
the lighting-value-change detector detects the change in the lighting value of the plurality of light sources based on the lighting value determined by the lighting value determination module.

7. A liquid crystal display apparatus comprising:
a liquid crystal panel;
a light emitter configured to illuminate the liquid crystal panel by a plurality of light sources each of which is provided with respect to each of a plurality of light source areas;
a light emission controller configured to control a light emission of the plurality of light sources;
a lighting-value-change detector configured to detect a change in a lighting value of the plurality of light sources; and
a lighting controller configured to turn on the plurality of light sources at a plurality of lighting timings within a lighting period defined between an initial lighting timing and a final lighting timing of the plurality of lighting timings by pulse width modulation in accordance with the change in the lighting value, a number of the lighting timings in a later lighting period of the lighting period being greater than a number of the lighting timings in an earlier lighting period of the lighting period

8. The liquid crystal display apparatus according to claim 7, wherein
the lighting controller delays at least one of the lighting timings, and turns on the plurality of light sources at the lighting timings so that the plurality of light sources are turned on within the later lighting period.

9. The liquid crystal display apparatus according to claim 8, wherein
the lighting controller controls the lighting timings so that the lighting timings converges to the final lighting timing, and turns on the plurality of light sources at the lighting timings
